(19) United States
(12) Patent Application Publication
(10) Pub. No.: US 2002/0031835 A1
(43) Pub. Date: Mar. 14, 2002

(54) Laboratory-on-a-chip device using wetting forces and thermal marangoni pumping

(75) Inventor: Leonard Schwartz, Newark, DE (US)

Correspondence Address: Connolly Bove Lodge & Hutz LLP, P.O. Box 2207, Wilmington, DE, 19899-2207, US

(73) Assignee: University of Delaware

(21) Appl. No.: 09/853,468

(22) Filed: May 11, 2001

Related U.S. Application Data
(60) Provisional application No. 60/203,597, filed on May 12, 2000.

(51) Int. Cl. B01L 3/00

(52) U.S. Cl. 436/180; 422/102; 422/99

(57) ABSTRACT

A laboratory on a chip device uses wetting forces and thermal marangoni pumping. This is accomplished by placing the liquid on a substrate having different wetting properties in different regions. The wetting forces cause the liquid to flow into predetermined channels. The liquid is driven by a temperature difference produced by an electrical heating element under the original point of drop deposition. The difference in liquid temperature causes a difference in surface temperature which yields a net force (marangoni effect) to move each liquid portion to its assigned position.

### CROSS-REFERENCE TO RELATED APPLICATION

This application is based upon provisional application Serial No. 60/203,597, filed May 12, 2000.

### GOVERNMENT LICENSE RIGHTS

The U.S. Government has a paid up license in this invention and the right in limited circumstances to require the patent owner to license others on reasonable terms as provided by the terms of research grant NAG 3-1920 awarded by NASA Microgavity Program.

### BACKGROUND OF THE INVENTION

The present invention relates to the miniaturization of laboratory components, particularly for the medical field. In such field the biological sample is available in only small quantities of liquid. It would be desirable to be able to move such small quantities of liquid on a solid surface.

### SUMMARY OF THE INVENTION

Object of this invention are to provide improved techniques for a laboratory on a chip device and to utilize wetting forces and thermal Marangoni pumping for practicing the invention.

In accordance with this invention the temperature gradients and wetting forces are utilized for better distribution of the small quantity of liquid. The invention could be used for medical testing including DNA analysis, bacteriological analysis, and general chemical analysis requiring automation where only small samples are available because of scarcity or expense. Suitable substrate materials would be selected with the correct thermal conductivity so that a temperature gradient can be maintained at the proper level.

### THE DRAWINGS

FIG. 1 is a schematic diagram of an analysis device wherein the small drop of liquid is placed near the intersection of the channels. Surface-tension-gradient forces distribute the liquid along the channels to a number of receptacles. These receptacles can be pre-seeded with various reagents. The driving force is supplied by a temperature gradient produced by the electrical heating element that is attached to the substrate.

FIG. 2 is the first in a sequence of snapshots of simulation results for a spreading liquid drop on a patterned substrate. The flow is driven by a combination of wetting forces and a thermal marangoni force. FIG. 2 shows the initial condition for simulation. One quarter of a symmetric pattern is shown contours of the drop and the wettability pattern are shown on the right side of the figure.

FIGS. 3-7 are views similar to FIG. 2 showing the simulation of time at 0.29 seconds, 1.1 second, 2.0 seconds, 8.8 seconds and 34.4 second respectively. In FIG. 7 the temperature gradient has been turned off. The individual drops relax to their final shapes.

### DETAILED DESCRIPTION

Recently there has been great interest in miniaturization of laboratory components, especially in the medical field. The technology is interdisciplinary and, depending on the discipline from which it springs, is often referred as “micro-electrical-mechanical systems,” or MEMS, or “laboratory on a chip.” In either case it is common to borrow fabrication techniques developed by the microelectronics industry. [See Ho & Tai (1998), Menz & Gruber (1994), Pethig et al (1998), Talary et al (1998).]

We consider here the preliminary design of a novel device that may be used to distribute microscopic quantities of liquid. It may find application as a medical diagnostic device in automatic testing machinery. It is a simple device with no moving parts, and the design may easily be adapted to accomodate a range of liquid volumes and rates of delivery. It can be manufactured using standard vapor deposition and photolithography techniques and a singe unit can be expected to cost very little if manufactured in quantity. Bacteriological and DNA testing are among the potential applications.

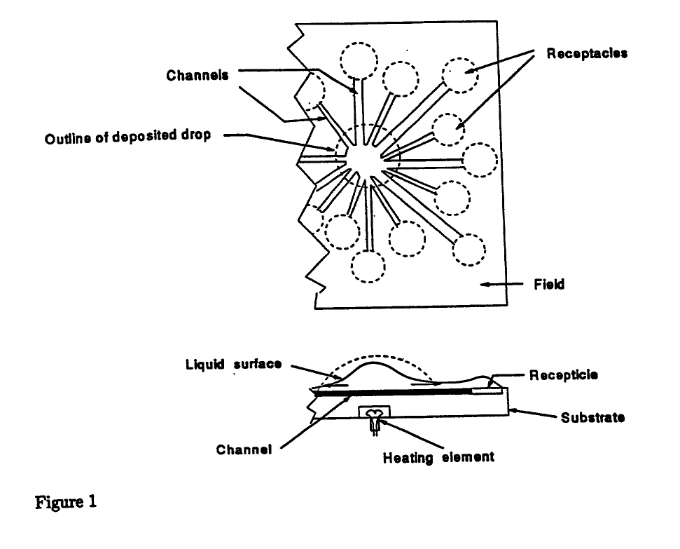

The unit consists of a flat substrate upon which particular patterns of wettability, that is equilibrium contact angle θₑ for the test liquid, have been applied. Because of surface tension, i. e. capillarity, liquid drops will move spontaneously from regions of high contact angle to regions of low contact angle. Three different values of θₑ, corresponding to three different surface treatments, are used in the pattern. The largest θₑ will be on the field, while the connecting channels and their central intersection have an intermediate value of θₑ. The smallest θₑ, which may correspond to a completely bare substrate, will be found on a number of small spots, called receptacles, that are the ultimate destinations for the liquid. Various regents may be applied to the receptacles during fabrication of the unit. The device is shown schematically in FIG. 1.

A single small drop of the liquid is deposited near the channel intersection. Wetting forces immediately draw the drop inward. In this sense the device is self-centering. Because the channels are more wettable, the liquid will begin to move outward along the channels as it recedes from the field. Depending on the contact angle values, the volume of liquid deposited, and the size of the device, the liquid may reach an equilibrium position before it reaches the receptacles. In order to ensure complete liquid transfer, and also to control the rate of filling, the device is fitted with a small electrical heating element under the channel intersection.

Surface tension is a decreasing function of temperature for liquids. A gradient of temperature will therefore produce a surface tension gradient. The resulting difference in surface force on a small element of liquid must be balanced by a surface stress. This surface stress will move the liquid in the direction of lower temperature. This is the so-called Marangoni effect that is the pumping mechanism for the device. For given thermal properties of the substrate and the liquid, varying the heat input will control the flow speed.

The ability to move a thin layer of liquid using a differentially-heated substrate was demonstrated experimentally some time ago (Ludviksson & Lightfoot, 1971). This work involved the removal of liquid from a bath and upward flow of the liquid onto a vertical wall. Motion was observed to stop when the moving liquid front reached a portion of the substrate upon which a high-contact-angle coating had been applied. Cazabat et al (1990) showed that, for a certain range of values of the Marangoni driving force, the liquid front can become unstable and form growing “fingers” of liquid. Using the same Marangoni-driven bath-withdrawal geometry, recently Kataoka & Troian (1999) have shown that application of stripes of octadecyltrichlorosilane (OTS) onto a silica substrate will cause the propagating liquid fingers to follow the more-wettable (smaller contact angle) paths. Organic liquids were used in these studies, squalane in the early study and silicone oil in the later work. Sammarco & Burns (1999) discuss the forced motion of discrete drops using the Marangoni driving effect. The required surface coatings can be applied as single monolayers. See Wasserman et al (1989).

In studies designed to investigate how liquid moves on a substrate that is contaminated with small patches of greasy material, we did experiments where patterns of 10 and 100 micron squares of silane were applied to a silica substrate. Theoretical methods for treating the flow were developed and the theory was in substantial agreement with experiment. [Schwartz & Garoff (1985a,b)] The wetting liquid was water. More recently we developed a general theoretical and numerical model for the unsteady three-dimensional simulation of flow of thin liquid layers and drops on mixed-wettable substrates [Schwartz (1998), Schwartz & Eley (1998)]. Mixed wettability is modeled using an extension of the “disjoining pressure” model that explains the physics of finite contact angles as developed originally by Frumkin (1938) and Derajuin (1940). We also performed experiments using a drop of glycerin on a glass slide to which a cross pattern of Teflon tape had been applied. The drop breaks up, under the influence of wetting forces, into a pattern of smaller droplets. The process takes about one minute. The experiment provided detailed confirmation of the numerical modeling results. More recently we have added thermal Marangoni driving forces to the model and have successfully simulated the fingering flows observed by Cazabat et al and the flow against the wettability barrier observed by Ludviksson & Lightfoot. [Eres et al (2000), Schwartz (2000)]

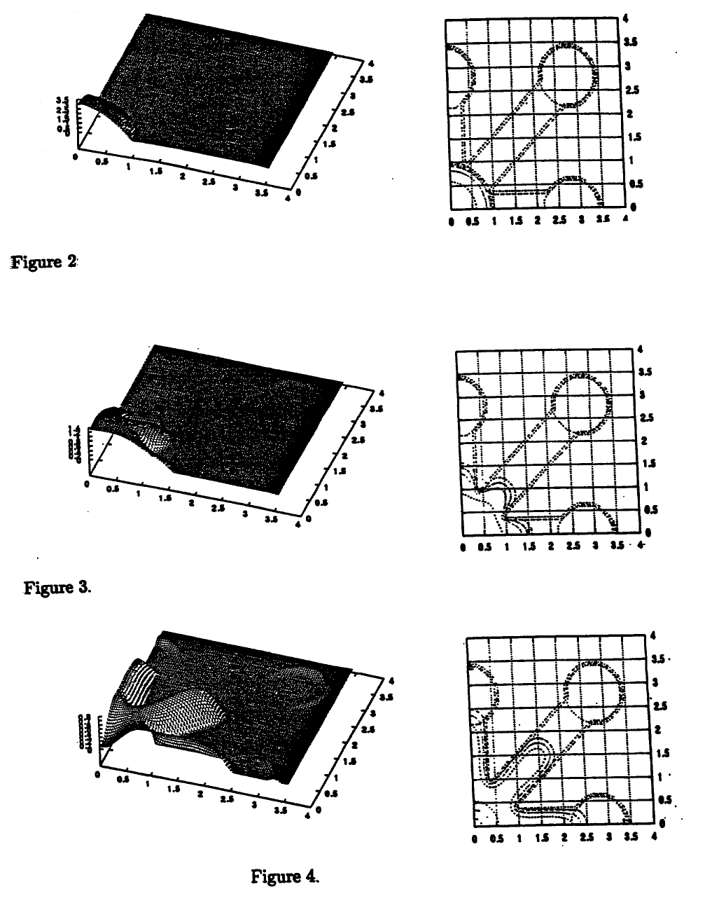

We have used our simulation capability to predict the performance of the device illustrated in FIG. 1. The simulation results are shown in FIGS. 2 through 7 where the liquid configuration is shown, as it evolves, at six different times. For simplicity, the flow is assumed to be symmetric in each of the four quadrants of the substrate and only one quadrant is shown. On the left of each figure is a wire-cage picture of the liquid surface while contours are shown on the right. The pictures on the right also show the wettability pattern including the channels and the receptacles.

Note that, as in FIG. 1, the channel widths are not all the same. Receptacles that are further away are connected to the center using wider channels. The channel widths are selected so that each receptacle receives the same quantity of liquid and fills in about the same time. The three contact angles for this simulation have been chosen to be in the ratios

θ_{recept}:θ_{channel}:θ_{field}=1:2:4.

The mathematical model used in the numerical simulation employs dimensionless variables. Thus this particular simulation is appropriate for various combinations of device dimensions, liquid properties, and contact-angle values. For definiteness, we use the following values: viscosity μ=0.01 poise, sur tension σ=50 dyne/cm, the contact angle θ_{field}=11.5°, the initial drop radius R₀=2 mm, the drop volume is 3.8 microliter, and the surface shear stress τ, assumed constant and directed radially outward, is 3.3 dyne/cm². R₀ is taken as the unit of length in each figure. The overall size of the device, one-quarter of which is shown in the figures, is 1.6 cm square. The difference in surface tension between the center and the edges of the device that is required to produce the strew τ is Δσ=2.6 dynes/cm. In order to produce this stress, a temperature difference of about 16° C. is required for aqueous solutions.

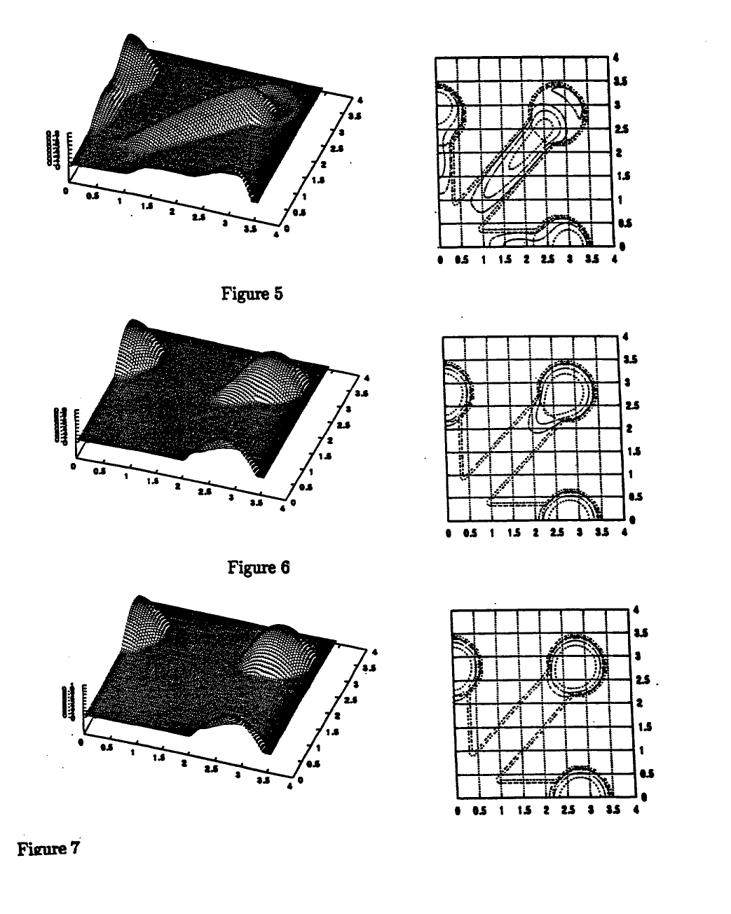

The droplet break-up, transport, and final position of the liquid on the receptacles is shown in FIGS. 3 to 8. The transfer of the liquid is essentially completed in about 8 sec and virtually all of the liquid has been moved to the receptacles. Simulation results use a calibration factor found by Schwartz & Eley (1998) where the theoretical solution was compared to experimental results for a similar droplet break-up problem. Thus results shown here are expected to be a time accurate model of the process. The temperature gradient was turned off before the final frame shown in FIG. 8; thus the final drawing of the liquid into the receptacles is due only to wetting forces since the receptacles are taken to be somewhat more wettable than the channels. Quite similar results would be obtained if the temperature gradient had been maintained. More viscous liquids would take a longer time for transfer; however the minimum temperature difference to fill the receptacles is independent of the viscosity. Gravity has not been included in the simulation. It can be added without difficulty but will only have a minor effect on the results for devices of small size.

The following is a more complete listing of the various above cited references.

Cazabat, A. M., Heslot, F., Troian, S. M. & Carles, P., Fingering instability of thin spreading films driven by temperature gradients, Nature 346, 824-826, 1990.

Derjaguin, B. V., Theory of the capillary condensation and other capillary phenomena taking into account the disjoining effect of long-chain molecular liquid films, Zhurnal Fizicheskoi Khimii 14, 137, 1940 (In Russian).

Eres, M. H., Schwartz, L. W. & Roy R V., Fingering phenomena for driven coating films, Phys. Fluids, 2000 (in press).

Gau, A. N., On the phenomena of wetting and sticking of bubbles, Zhurnal Fizicheskoi Khimii 12, 337, 1938 (In Russian).

Gau, H., Herminghaus, S., Lenz, P. and Lipowsky, R., “Liquid morphologies on structured surfaces; from microchannels to microchips”, Science 283, 46-49, 1999.

Ho C. M. & Tai Y. C., “Micro-electro-mechanical-systems (MEMS) and fluid flows,” Ann. Rev. Fluid Mech. 30 579-612 1998

Kataoka DE & Troian SM, “Patterning liquid flow on the microscopic scale,” Nature 402, 794-797, 1999.

Lenz, P., “Wetting phenomena on structured surfaces” Adv. Mater.11, 1531, 1999.

Ludviksson, V. & Lightfoot, E. N., “The dynamics of thin liquid films in the presence of surface-tension gradients,” AIChE J. 17, 1166-1173, 1971.

Menz, W. & Gruber, A., Microstructure technologies and their potential in medical applications, Minimally Invasive Neurosurgery 37, 21-27, 1994.

Pethig, R., Burt, J. P. H., & Parton, A., “Development of biofactory-on-a-chip technology using excimer laser micromachining,” J. Micromech Microeng. 8,57-3, 1998.

Sammarco, T. S. & Burns, M. A., “Thermocapillary pumping of discrete drops in microfabricated analysis devices,” AICHE J. 45, 350-366, 1999.

Schwartz, L. W., “Hysteretic Effects in Droplet Motions on Heterogeneous Substrates: Direct Numerical Simulation,” Langmuir 14, 3440-3453, 1998.

Schwartz, L. W., “On the asymptotic analysis of stress-driven thin-layer flow,” J. Engrg. Maths., 2000 (submitted).

Schwartz, L. W. & Eley, R. R., “Simulation of Droplet Motion on Low-Energy and Heterogeneous Surfaces,” J. Colloid & Interface Sci. 202, 173-188, 1998.

Schwartz, L. W. & Garoff S., “Contact angle hysteresis on heterogeneous surfaces,” Langmuir 1, 219 (1985a).

Schwartz, L. W. & Garoff, S., “Contact angle hysteresis and the shape of the three-phase line,” J. Colloid Interface Sci. 106, 422 (1985b).

Talary M. S., Burt, J. P. H. & Pethig, R., “Future trends in diagnosis using laboratory-on-a-chip technologies,” Parasitology 117, S191-S203, 1998.

Wasserman, S. R., Whitesides, G. M., Tidswell, I. M., Ocko, B. M., Pershan, P. S. & Axe, J. D., “The structure of self-assembled monolayers of alkylsiloxanes on silicon—A comparison of results from ellipsometry and low-angle X-ray reflectivity,” J. Am. Chem. Soc. 111, 5852-5861, 1989.

What is claimed is:

1. A laboratory on a chip device comprising a substrate having different wetting properties in different substrate regions, and an electrical heating element for producing a temperature difference of a liquid on the substrate.

2. A method of distributing a liquid on a substrate comprising providing a substrate with different wetting properties in different substrate regions, placing a liquid on the substrate utilizing the wetting forces to cause the liquid to flow into predetermined channels, creating a temperature difference to drive the liquid as a result of an electrical heating element under the original point of drop deposition, causing a difference in surface tension as a result of the difference in liquid temperature, and yielding a net force from the surface temperature differences to move each liquid portion.
